(19) United States
(12) Patent Application Publication
(10) Pub. No.: US 2025/0158325 A1
(43) Pub. Date: May 15, 2025

(54) Split Parallel Connector

(71) Applicant: DMC Power, Inc., Carson, CA (US)

(72) Inventors: Eyass Khansa, Long Beach, CA (US); Roy Perez, San Dimas, CA (US); Anas Rochdi, Memphis, TN (US)

(73) Assignee: DMC Power, Inc., Carson, CA (US)

(21) Appl. No.: 18/508,234

(22) Filed: Nov. 14, 2023

(51) Int. Cl. H01R 13/627; H01R 13/655

(52) U.S. Cl. CPC H01R 13/6273; H01R 13/655

(57) ABSTRACT

A split parallel connector comprises first and second body members configured to be interlocked around parallel conductors to be electrically and mechanically coupled. Channel cuts are formed in the body members to receive the conductors. Locking mechanisms are formed in the body members to secure the body members together before a compressive force is applied. The locking mechanisms comprise a projection formed on a tab that projects into a vertically-aligned recess formed in a groove to restrict relative motion in five degrees of freedom between the first and second body members. Cut-outs formed in the first and second body members to eliminate excess material are strategically placed and configured to efficiently direct swaging forces to the conductors without causing damage to the swage dies.

### FIELD

This disclosure relates generally to connectors for electrical conductors and, more particularly, to swaged split parallel connectors for use in grounding applications.

### BACKGROUND

Connectors are used to electrically and mechanically couple conductors to establish a reliable and efficient path for transmission of electricity between different components or systems. Connectors should provide a solid and stable electrical connection between conductors and maintain high conductivity, ensuring efficient power transfer with minimal electrical resistance or energy loss. Connectors should also provide a robust mechanical coupling, firmly holding the conductors in place to maintain the integrity of the electrical connection over time.

In grounding applications, grounding connectors are used to establish a safe path for electrical currents to reach the earth. In an electrical substation, for example, grounding connectors play an important role in the grounding system. A substation typically includes an interconnected grounding grid of conductive materials that is buried in the ground within and around the substation to provide a low resistance path to ground. Substation equipment is coupled to the grounding grid by grounding conductors such as cables, rods, or bars. Grounding connectors are used to join grounding conductors together and to join grounding conductors to grid conductors, thereby enabling joining and separation of the grounding conductors without the need for cutting or splicing.

In this context, split parallel grounding connectors are designed to mechanically and electrically join multiple grounding conductors in parallel. Split parallel grounding connectors take various forms and generally include separate body members that are securely fastened around the grounding conductors using a compressive force. The compressive force is sometimes supplied by crimping, which typically concentrates the compressive force at one or a few locations around the circumference of the conductors and can result in a poor electrical connection. Swaging, by contrast, is a process that distributes compressive force evenly around the circumference of a cylindrical connector. A properly swaged connector generally provides a superior connection relative to a crimped connector.

### SUMMARY

This disclosure provides a split parallel grounding connector having an improved locking mechanism that increases the holding strength of the connection and restricts relative movement between the separate body members of the connector. Cut-outs for eliminating excess material are strategically placed and configured to efficiently direct swaging forces to the conductors without causing damage to the swage dies. The body members are of equal strength to mitigate against failures of the locking mechanism.

One aspect of this disclosure is a split parallel connector comprising first and second body members configured to be interlocked around parallel conductors to be electrically and mechanically coupled. Channel cuts are formed in the first and second body members to receive the parallel conductors. Locking mechanisms are formed in the first and second body members and configured to secure the first and second body members together before a compressive force is applied. Each of the locking mechanisms comprises a projection formed on a tab that projects into a vertically-aligned recess formed in a groove to restrict relative motion between the first and second body members.

In some implementations, each of the locking mechanisms comprises a tab formed on the second body member that includes a descendant projection that interlocks with a vertically-aligned ascendant recess formed in a groove in the first body member, and a tab formed on the first body member that includes an ascendant projection that interlocks with a vertically-aligned descendant recess formed in a groove in the second body member.

In some implementations, the channel cuts are configured in a single channel configuration in which the conductors are held in a single channel.

In some implementations, the channel cuts are configured in a dual channel configuration in which the conductors are held in separate channels. In one example of a dual channel configuration, a first locking tab is formed at a central intersection of the channel cuts formed in the first body member, a second locking tab is formed at a central intersection of the channel cuts formed in the second body member, and the first and second locking tabs abut to further restrict relative lateral motion between the first and second body members.

Another aspect of this disclosure is a split parallel connector comprising first and second body members configured to be interlocked around parallel conductors to be electrically and mechanically coupled. Channel cuts are formed in the first and second body members to receive the parallel conductors. Cut-outs are formed in the first and second body members to eliminate excess material and may be offset relative to a central vertical axis of the connector to efficiently direct swaging forces to the conductors.

In some implementations, a first cut-out is oriented above a first channel defined by the channel cuts and a second cut-out is oriented below a second channel defined by the channel cuts.

In some implementations, each of the cut-outs includes a narrow slot cut-out portion formed in an outer cylindrical surface of the connector that opens to a larger and radially inward cut-out portion that is spaced from the outer cylindrical surface. The radially inward cut-out portion may have a circular configuration.

Various additional aspects of this disclosure are depicted and described in the accompanying drawings and the following description.

### BRIEF DESCRIPTION OF THE DRAWINGS

Various features and advantages of this disclosure will be apparent from the following description and accompanying drawings. The drawings are not necessarily to scale; emphasis instead is placed on illustrating the principles of this disclosure. In the drawings, like reference characters may refer to the same parts throughout the figures. The drawings depict illustrative examples and are not limiting in scope.

FIG. 1A is a perspective view of a split parallel connector in an assembled state, according to a first embodiment of this disclosure.

FIG. 1B is side elevation view of the connector of FIG. 1A in a disassembled state, according to the first embodiment of this disclosure.

FIG. 1C is a side elevation view of the connector of FIG. 1A in an assembled state, according to the first embodiment of this disclosure.

FIG. 2A is a perspective view of a split parallel connector in an assembled state, according to a second embodiment of this disclosure.

FIG. 2B is side elevation view of the connector of FIG. 2A in a disassembled state, according to the second embodiment of this disclosure.

FIG. 2C is a side elevation view of the connector of FIG. 2A in an assembled state, according to the second embodiment of this disclosure.

FIG. 3A is a perspective view of a split parallel connector in an assembled state, according to a third embodiment of this disclosure.

FIG. 3B is side elevation view of the connector of FIG. 3A in a disassembled state, according to the third embodiment of this disclosure.

FIG. 3C is a side elevation view of the connector of FIG. 3A in an assembled state, according to the third embodiment of this disclosure.

### DETAILED DESCRIPTION

In the following description, for purposes of explanation and not limitation, specific details are set forth in order to provide a thorough understanding of this disclosure. However, it will be apparent to one skilled in the art that this disclosure may be practiced in other embodiments that depart from these specific details. In addition, detailed descriptions of well-known devices and methods may be omitted so as to not obscure this disclosure with unnecessary detail.

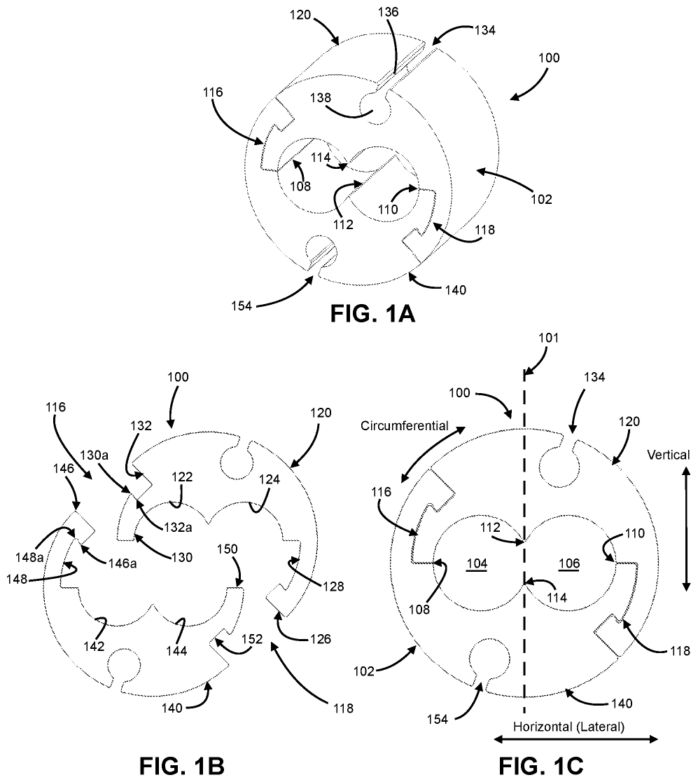

FIGS. 1A-1C illustrate a split parallel connector 100, according to a first embodiment of this disclosure. Connector 100 is used to electrically and mechanically join two separate electrical conductors that are oriented in parallel to each other at the point of connection (i.e., within connector 100). Connector 100 is made of a suitably conductive and malleable material, such as copper. In one example, connector 100 is made of a high-purity copper, such as electrolytic tough pitch copper. Various types of electrical conductors may be joined by connector 100 including, without limitation, conductive cable (i.e., copper-clad, copper stranded, or solid copper cable), ground rod (i.e., solid copper or copper clad/bonded rod), and rebar.

The design of connector 100 is such that no cutting or splicing is required to join the two conductors. When assembled (FIGS. 1A, 1C), connector 100 defines a cylindrical outer surface 102 that serves as a swaging or crimping region. A swage or crimp tool placed around cylindrical outer surface 102 applies a compressive radial force to permanently deform connector 100 around the two conductors. Swaging is advantageous in that it distributes compressive force evenly around outer surface 102 and generally provides a superior connection relative to crimping.

Connector 100 comprises first body member 120 and second body member 140. In some examples, such as the example of FIGS. 1A-1C, first and second body members 120 and 140 are identical, interlocking bodies. In other examples, first and second body members 120 and 140 may not be identical. First and second body members 120 and 140 are interlocked around the conductors to be joined. Semi-cylindrical channel cuts 122 and 124 are machined or otherwise formed in the interior surface of first body member 120, and semi-cylindrical channel cuts 142 and 144 are machined or otherwise formed in the interior surface of second body member 140. Channel cuts 122, 124, 142, 144 may also be referred to herein as troughs, grooves, or indentations.

When first and second body members 120, 140 are brought together, channel cuts 122, 124 align with channel cuts 142, 144 to form hollow spaces 104 and 106 that match the shape and size of the conductors to be joined. In the embodiment of FIGS. 1A-1C, the channel cuts are formed such that, when brought together, the radially outer edges of channel cuts 122, 124 abut or contact the radially outer edges of channel cuts 142, 144 (see edge lines 108, 110) to define a continuous radially outer surface that encloses the radially outer peripheries of spaces 104 and 106. The radially inner edges of channel cuts 122, 124, by contrast, are spaced from the radially inner edges of channel cuts 142, 144 (see spaced edge lines 112, 114) such that spaces 104 and 106 are part of a single channel. Thus, connector 100 of FIGS. 1A-1C may be referred to as a single channel split parallel conductor.

Connector 100 has locking mechanisms 116 and 118 on opposing sides to secure first and second body members 120 and 140 together around the conductors before swaging. Locking mechanisms 116 and 118 ensure proper alignment of body members 120, 140 around the conductors and helps to prevent potential misalignments, which could lead to inefficiencies or damage during the swaging process. This pre-swaging securement also maintains the conductors in place and helps to prevent shifting or relative movement during swaging, which could result in an improperly formed connection. In addition, by securing body members 120, 140 before swaging, the operator's hands are freed up to operate the swaging tool without having to physically hold or secure body members 120, 140 in place. The risk of accidental injury due to contact with the swaging tool is reduced, and the operator is able to focus on the swaging operation without the distraction of holding body members 120, 140 in place.

Locking mechanisms 116, 118 have a dual tab-groove configuration that restricts relative motion between body members 120, 140 in five degrees of freedom. That is, a 3-dimensional rigid body in space has six degrees of freedom: three translational degrees of freedom and three rotational degrees of freedom. If we consider motion with respect to an X-Y-Z coordinate system, where x, y, and z are mutually perpendicular axes (directions) of the coordinate system, then the six degrees of freedom are translation in the x, y, z directions, and rotation about the x, y, z axes. Connector 100 restricts the relative motion of one part (i.e., first body member 120) relative to the other part (i.e., second body member 140) in five degrees of freedom. Thus, if body members 120 and 140 are assembled and one of the body members is held fixed, the other body member is prevented from rotating in all three directions and is prevented from translating in two directions (the horizontal and vertical directions, with respect to FIG. 1C). The only relative motion that is allowed is translation in one direction, i.e., body members 120 and 140 can only slide past each other along the direction that is in and out of the page with respect to FIG. 1C.

As shown in FIG. 1B, locking mechanism 116 comprises locking tab 146 of body member 140 that fits into correspondingly shaped locking groove 132 of body member 120, and locking tab 130 of body member 120 that fits into correspondingly shaped locking groove 148 of body member 140. Tab 146 and groove 132, and tab 130 and groove 148, are formed to match each other in shape, size and alignment. When body members 120, 140 are brought together, tab 146 locks into groove 132 and tab 130 locks into groove 148. Once interlocked, the tabs and grooves prevent relative movement of body members 120, 140 in five degrees of freedom as discussed above, with the only relative movement allowed being sliding past each other along the direction that is in and out of the page in FIG. 1C. Movement in any other direction would require the tabs to be pulled out of the grooves.

In more detail, tab 146 includes a descendant projection 146a that interlocks within a vertically-aligned ascendant recess 132a of groove 132. Similarly, tab 130 includes an ascendant projection 130a that interlocks within a vertically-aligned descendant recess 148a of groove 148. This configuration restricts relative movement between interconnected body members 120 and 140. The vertical alignment and insertion of the projections into the recesses secures the assembly and prevents relative movement. This ensures a robust, secure connection between body members 120, 140 that maintains its integrity under various conditions and resists forces that may induce displacement or relative motion.

Locking mechanism 118 is identical to locking mechanism 116, with the orientations of the locking tabs and grooves reversed. In locking mechanism 116, tab 146 of body member 140 is radially outer to tab 130 of body member 120. In locking mechanism 118, tab 126 of body member 120 is radially outer to tab 150 of body member 140. By this configuration, the connector halves (body members 120 and 140) are of essentially the same configuration and of equal strength, which mitigates against failures of the locking mechanism that may be caused if the connector halves are of mismatched strength and/or configuration.

The operation of locking mechanism 118 is otherwise the same as the operation of locking mechanism 116, with tab 150 of body member 140 fitting into correspondingly shaped groove 128 of body member 120, and tab 126 of body member 120 fitting into correspondingly shaped groove 152 of body member 140. As in locking mechanism 116, tab 150 includes a descendant projection that interlocks within an ascendant recess of groove 128, and tab 126 includes an ascendant projection that interlocks within a descendant recess of groove 152. In this manner, locking mechanisms 116, 118 work in tandem, with the vertical alignment and insertion of projections into recesses in both locking mechanisms securing the assembly and preventing relative motion in five degrees of freedom.

Connector 100 may also include cut-outs that eliminate excess material. In the example of FIGS. 1A-1C, cut-out 134 is formed in body member 120 and cut-out 154 is formed in body member 140. Cut-outs 134, 154 are strategically placed to efficiently direct swaging forces to the conductors to improve the strength of the connection. In particular, as can be seen in FIG. 1C, cut-outs 134, 154 are offset relative to central vertical axis 101 of connector 100, with cut-out 134 being offset to the right of axis 101 and above space 106, and with cut-out 154 being offset to the left of axis 101 and above space 104. In addition, the design of cut-outs 134, 154 is such that they do not result in damage to the swage (or crimp) dies during installation. In particular, each cut-out includes a relatively narrow slot cut-out portion formed in outer cylindrical surface 102 that opens to a larger (in one example, circular) and radially inward cut-out portion that is spaced from surface 102. As shown in FIG. 1A, for example, cut-out 134 includes narrow slot cut-out portion 136 formed in outer cylindrical surface 102 that opens to larger and radially inward cut-out portion 138 that is spaced from surface 102. In one embodiment, the larger and radially inward cut-out portion 138 may be circular. Cut-out portion 154 is formed in the same manner as cut-out portion 134.

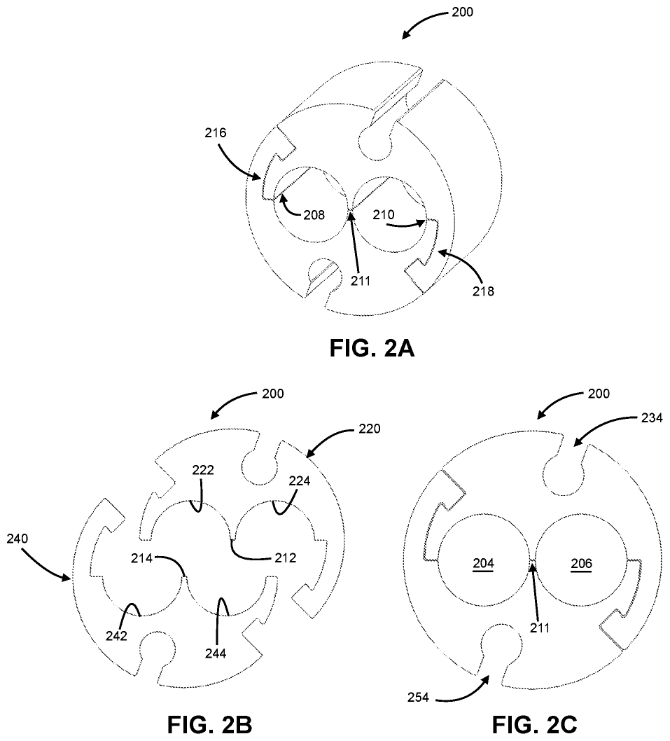

FIGS. 2A-2C illustrate a split parallel connector 200, according to a second embodiment of this disclosure. Connector 200 is identical to connector 100 in most respects, except that its channel cuts are formed to provide a dual channel configuration. As in connector 100, when first and second body members 220, 240 are brought together, channel cuts 222, 224 align with channel cuts 242, 244 to form hollow spaces 204 and 206 that match the shape and size of the conductors to be joined. The radially outer edges of channel cuts 222, 224 abut or contact the radially outer edges of channel cuts 242, 244 (see edge lines 208, 210) to define a continuous radially outer surface that encloses the radially outer peripheries of spaces 204 and 206.

Connector 200 differs from connector 100 in that the radially inner edges of channel cuts 222, 224 contact or abut the radially inner edges of channel cuts 242, 244 when brought together (see edge line 211) such that spaces 204 and 206 each form their own, separate channel. In particular, a flat surface or shoulder 212 is formed at the central intersection of channel cuts 222, 224, and a flat surface or shoulder 214 is formed at the central intersection of channel cuts 242, 244. When brought together, flat shoulders 212, 214 are in contact and close off spaces 204, 206 from each other such that each of spaces 204, 206 forms its own separate channel. Thus, connector 200 of FIGS. 2A-2C may be referred to as a dual channel split parallel conductor.

Connector 200 of FIGS. 2A-2C is identical in all other respects to connector 100 of FIGS. 1A-1C. Connector 200 has locking mechanisms 216 and 218 on opposing sides to secure first and second body members 220 and 240 together around the conductors before swaging. Locking mechanisms 216, 218 have a dual tab-groove configuration that restricts relative motion between body members 220, 240 in five degrees of freedom, in particular, projections interlock within vertically-aligned recesses to restrict displacement or relative motion between interconnected body members 220 and 240. Connector 200 may also include cut-outs 234, 254 that are strategically placed and configured in the same manner as cut-outs 134, 154 of connector 100.

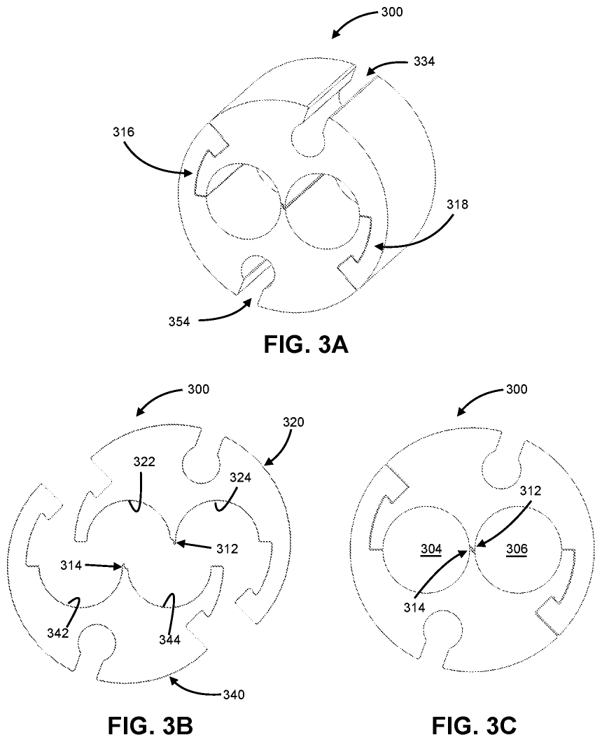

FIGS. 3A-3C illustrate a split parallel connector 300, according to a third embodiment of this disclosure. Like connector 200, connector 300 has a dual channel configuration in which each of spaces 304, 306 forms its own separate channel. However, in connector 300, rather than flat abutting shoulders, a locking tab 312 is formed at the central intersection of channel cuts 322, 324, and a locking tab 314 is formed at the central intersection of channel cuts 342, 344. When brought together, locking tabs 312 and 314 abut to further restrict lateral or horizontal displacement between interconnected body members 320 and 340. This is in addition to the restriction on relative movement in five degrees of freedom already imposed by locking mechanisms 316, 318. Thus, while locking tabs 312, 314 are not required to prevent horizontal displacement in a dual channel configuration (see, i.e., connector 200 of FIGS. 2A-2C), they may be included to enhance the horizontal displacement mitigation already provided by locking mechanisms 316, 318.

Connector 300 of FIGS. 3A-3C is identical in all other respects to connector 200 of FIGS. 2A-2C. Connector 300 has locking mechanisms 316 and 318 on opposing sides to secure first and second body members 320 and 340 together around the conductors before swaging. Locking mechanisms 316, 318 have a dual tab-groove configuration that restricts relative motion between body members 320, 340, in particular, projections interlock within vertically-aligned recesses to restrict relative movement in five degrees of freedom between interconnected body members 320 and 340. Connector 300 may also include cut-outs 334, 354 that are strategically placed and configured in the same manner as cut-outs 234, 254 of connector 200.

The embodiments described herein may be implemented in other forms without departing from the spirit and scope of this disclosure. Thus, the invention is not limited by the foregoing illustrative details, but rather is defined by the following claims.

1. A split parallel connector comprising:
first and second body members configured to be interlocked around parallel conductors to be electrically and mechanically coupled;
channel cuts formed in the first and second body members to receive the parallel conductors; and
locking mechanisms formed in the first and second body members and configured to secure the first and second body members together before a compressive force is applied,
wherein each of the locking mechanisms comprises a projection formed on a tab that projects into a vertically-aligned recess formed in a groove to restrict relative motion between the first and second body members.

2. The split parallel connector of claim 1, comprising first and second locking mechanisms configured on opposing sides of the connector.

3. The split parallel connector of claim 2, wherein each of the first and second locking mechanisms comprises:
a tab formed on the second body member that includes a descendant projection that interlocks with a vertically-aligned ascendant recess formed in a groove in the first body member; and
a tab formed on the first body member that includes an ascendant projection that interlocks with a vertically-aligned descendant recess formed in a groove in the second body member.

4. The split parallel connector of claim 1, wherein the channel cuts are configured in a single channel configuration in which the conductors are held in a single channel.

5. The split parallel connector of claim 4, wherein a central intersection of the channel cuts formed in the first body member is spaced from a central intersection of the channel cuts formed in the second body member.

6. The split parallel connector of claim 1, wherein the channel cuts are configured in a dual channel configuration in which the conductors are held in separate channels.

7. The split parallel connector of claim 6, wherein
a first shoulder is formed at a central intersection of the channel cuts formed in the first body member;
a second shoulder is formed at a central intersection of the channel cuts formed in the second body member; and
the first and second shoulders are in contact and separate the channel cuts into the separate channels.

8. The split parallel connector of claim 6, wherein
a first locking tab is formed at a central intersection of the channel cuts formed in the first body member; and
a second locking tab is formed at a central intersection of the channel cuts formed in the second body member, wherein
the first and second locking tabs abut to further restrict relative lateral motion between the first and second body members.

9. A split parallel connector comprising:
first and second body members configured to be interlocked around parallel conductors to be electrically and mechanically coupled;
channel cuts formed in the first and second body members to receive the parallel conductors; and
cut-outs formed in the first and second body members to eliminate excess material, the cut-outs being offset relative to a central vertical axis of the connector to efficiently direct swaging forces to the conductors.

10. The split parallel connector of claim 9, wherein a first cut-out is oriented above a first channel defined by the channel cuts and a second cut-out is oriented below a second channel defined by the channel cuts.

11. The split parallel connector of claim 9, wherein each of the cut-outs includes a narrow slot cut-out portion formed in an outer cylindrical surface of the connector that opens to a larger and radially inward cut-out portion that is spaced from the outer cylindrical surface.

12. The split parallel connector of claim 11, wherein the radially inward cut-out portion has a circular configuration.

13. The split parallel connector of claim 9, wherein the channel cuts are configured in a single channel configuration in which the conductors are held in a single channel.

14. The split parallel connector of claim 9, wherein the channel cuts are configured in a dual channel configuration in which the conductors are held in separate channels.

15. The split parallel connector of claim 14, wherein
a first locking tab is formed at a central intersection of the channel cuts formed in the first body member; and
a second locking tab is formed at a central intersection of the channel cuts formed in the second body member, wherein
the first and second locking tabs abut to restrict relative lateral motion between the first and second body members.

16. A split parallel connector comprising:
first and second body members configured to be interlocked around parallel conductors to be electrically and mechanically coupled;
channel cuts formed in the first and second body members to receive the parallel conductors;
first and second locking mechanisms formed in the first and second body members and configured to secure the first and second body members together before a compressive force is applied, wherein the first and second locking mechanisms each comprise a projection formed on a tab that projects into a vertically-aligned recess formed in a groove to restrict relative motion between the first and second body members; and
cut-outs formed in the first and second body members to eliminate excess material.

17. The split parallel connector of claim 16, wherein each of the first and second locking mechanisms comprises:
a tab formed on the second body member that includes a descendant projection that interlocks with a vertically-aligned ascendant recess formed in a groove in the first body member; and
a tab formed on the first body member that includes an ascendant projection that interlocks with a vertically-aligned descendant recess formed in a groove in the second body member.

18. The split parallel connector of claim 17, wherein the cut-outs are offset relative to a central vertical axis of the connector to efficiently direct swaging forces to the conductors.

19. The split parallel connector of claim 18, wherein each of the cut-outs includes a narrow slot cut-out portion formed in an outer cylindrical surface of the connector that opens to a larger and radially inward cut-out portion that is spaced from the outer cylindrical surface.

20. The split parallel connector of claim 19, wherein
the channel cuts are configured in a dual channel configuration in which the conductors are held in separate channels;
a first locking tab is formed at a central intersection of the channel cuts formed in the first body member;
a second locking tab is formed at a central intersection of the channel cuts formed in the second body member; and
the first and second locking tabs abut to restrict relative lateral motion between the first and second body members.
